(19) United States
(12) Patent Application Publication
(10) Pub. No.: US 2024/0006627 A1
(43) Pub. Date: Jan. 4, 2024

(54) DISTRIBUTOR PLATE FOR AN ELECTROCHEMICAL CELL, METHOD FOR PRODUCING THE DISTRIBUTOR PLATE, ELECTROCHEMICAL CELL, AND METHOD FOR OPERATING THE ELECTROCHEMICAL CELL

(71) Applicant: Robert Bosch GmbH, Stuttgart (DE)

(72) Inventors: Alexander Eifert, Friolzheim (DE); Manuel Schneiter, Boeblingen (DE); Stefan Klenge, Gerlingen (DE); Ulrich Berner, Stuttgart (DE); Jan Hendrik Ohs, Renningen (DE); Veronika Schleper, Leinfelden-Echterdingen (DE)

(21) Appl. No.: 18/250,854

(22) PCT Filed: Oct. 6, 2021
(86) PCT No.: PCT/EP2021/077522

§ 371 Date: Apr. 27, 2023

(30) Foreign Application Priority Data
Oct. 29, 2020 (DE) 10 2020 213 591.6

(51) Int. Cl. H01M 8/026; H01M 8/04119; H01M 8/0265

(52) U.S. Cl. CPC H01M 8/026; H01M 8/04156; H01M 8/0265

(57) ABSTRACT

The invention relates to a distributor plate (7) for an electrochemical cell (1), the distributor plate (7) having a structure comprising connecting portions (12) with surfaces (13), and main ducts (11) having floor surfaces (33).

The surfaces (13) and optionally on the floor surfaces (33) of the secondary ducts (15) are provided with a pattern (92) and

the distributor plate (7) has at least two regions (94) in which the patterns (92) on the surfaces (13) differ from one another. The invention further relates to a method for producing the distributor plate (7), an electrochemical cell (1), and a method for operating an electrochemical cell (1).

### BACKGROUND

The invention relates to a distributor plate for an electrochemical cell, the distributor plate having a structure comprising connecting portions with surfaces and main ducts having floor surfaces. The invention further relates to a method for producing the distributor plate, an electrochemical cell comprising the distributor plate, and a method for operating the electrochemical cell.

Electrochemical cells are electrochemical energy transducers and are known in the form of fuel cells or electrolyzers.

A fuel cell converts the chemical reaction energy of a continuously supplied fuel and an oxidizing agent into electrical energy. In known fuel cells, hydrogen (H₂) and oxygen (O₂) are in particular converted to water (H₂O), electrical energy, and heat.

Proton-exchange membrane (PEM) fuel cells are known, among others. Proton-exchange membrane fuel cells comprise a centrally arranged membrane that is permeable to protons, i.e. hydrogen ions. The oxidizing agent, in particular atmospheric oxygen, is thereby spatially separated from the fuel, in particular hydrogen.

Fuel cells comprise an anode and a cathode. The fuel is supplied to the fuel cell at the anode and catalytically oxidized with loss of electrons to form protons that reach the cathode. The lost electrons are discharged from the fuel cell and flow via an external circuit to the cathode.

The oxidizing agent, in particular atmospheric oxygen, is supplied to the fuel cell at the cathode and reacts to form water by receiving the electrons from the external circuit and protons. The resulting water is drained from the fuel cell. The gross reaction is:

O₂+4H⁺+4e⁻→2H₂O

A voltage is in this case applied between the anode and the cathode of the fuel cell. In order to increase the voltage, a plurality of fuel cells can be mechanically arranged one behind the other to form a fuel cell stack, which can also be referred to as a fuel cell system, and can be electrically connected in series.

A stack of electrochemical cells typically has end plates that press the individual cells together and impart a stability onto the stack. The end plates can also serve as a positive or negative pole of the stack for discharging the current.

The electrodes, i.e. the anode and the cathode, and the membrane can be structurally assembled to form a membrane-electrode assembly (MEA).

Stacks of electrochemical cells further have bipolar plates, also referred to as gas distributor plates or distributor plates. Bipolar plates serve to distribute the fuel evenly to the anode and to distribute the oxidizing agent evenly to the cathode. Furthermore, bipolar plates usually have a surface structure, in particular duct-like structures, for distributing the fuel and the oxidizing agent to the electrodes. In particular in fuel cells, the duct-like structures also serve to drain the water produced during the reaction. In addition, the bipolar plates can comprise structures for passing a cooling medium through the electrochemical cell in order to discharge heat.

In addition to the media guidance with respect to oxygen, hydrogen, and water, the bipolar plates ensure a planar electrical contact to the membrane.

For example, a fuel cell stack typically comprises up to a few hundred individual fuel cells stacked one on top of the other in layers as so-called sandwiches. The individual fuel cells comprise one MEA and a bipolar plate half on both the anode side and the cathode side. In particular, a fuel cell comprises an anode monopolar plate and a cathode monopolar plate, typically each in the form of embossed sheets, which together form the bipolar plate and thus form ducts for guiding gas and liquids, between which the cooling medium flows.

Furthermore, electrochemical cells typically comprise gas diffusion layers for gas distribution. The gas diffusion layers are arranged between a bipolar plate and a MEA and are typically constructed on the duct side, i.e., in the direction of the adjacent bipolar plate, from a carbon fiber nonwoven fabric, which is also referred to as “gas diffusion backing” (GDB), and on the catalyst side, i.e., in the direction of the membrane, from a microporous layer, which is also referred to as “micro porous layer” (MPL).

In contrast to a fuel cell, an electrolyzer is an energy converter, which, while applying electrical voltage, preferably splits water into hydrogen and oxygen. Electrolyzers also have MEAs, bipolar plates, and gas diffusion layers, among other things.

For the efficiency of an electrochemical cell, in particular with a polymer electrolyte membrane, it is particularly important to homogeneously supply reaction gas to the electrode layers arranged on the membrane.

Known distributor plates in particular have ducts and respectively abutting or adjacent connecting portions that form a structure. The ducts are also referred to as main ducts or ducts and the connecting portions can be called lands. Surfaces of the connecting portions at least partially parallel to the extension plane of the distributor plate comprise contact surfaces of the distributor plate to an adjacent gas diffusion layer of the electrochemical cell. Gaseous hydrogen and oxygen pass the gas diffusion layer from the ducts of the distributor plate to the reaction zone on the membrane. The regions of the gas diffusion layer, which rest on the connecting portions of the distributor plate and thus the corresponding regions of the underlying MEA, are supplied comparatively poorly with reaction gas, in particular under flooding conditions of the electrochemical cell, which can lead to an undesirable inhomogeneous current density distribution.

On the side of the membrane at which air, i.e. oxygen, is supplied, water is produced in the operation of the fuel cell, which must be transported through the gas diffusion layer to the ducts of the distributor plate and removed from the cell there. Typical operating temperatures for electrochemical cells having a membrane are less than 120° C., so the water typically condenses in the gas diffusion layer and is present in liquid form. In the gas diffusion layer, the transport direction of the water is opposite to the transport direction of the gas, and accumulated water can severely impede the feeding of reaction gas, in particular oxygen.

The higher the power density of the electrochemical cell, the more water is produced, so the discharge of the amounts of liquid water in the contact region between the gas diffusion layer and air duct side of the distributor plates may be insufficient.

JP 2020-47441 A describes an improved drainage system for bipolar plates in which additional flutes are provided in flanks of the connecting portions parallel to the direction of the main ducts.

JP 2020-47443 A describes bipolar plates with improved water drainage, wherein connecting portions of the bipolar plates have an additional duct system arranged transversely to the direction of the main ducts. Each of two ducts of the additional duct system has a common drain. Furthermore, transverse structures in main ducts of a distributor plate, leading to high pressure loss, are disclosed.

JP 2020-47440 A also relates to bipolar plates with an improved drainage system, wherein the connecting portions have notches transverse to the direction of the main ducts and additional flutes along the flanks of the connecting portions parallel to the direction of the main ducts.

### SUMMARY

A distributor plate for an electrochemical cell is proposed, the distributor plate having a structure comprising connecting portions with surfaces and main ducts having floor surfaces, the surfaces and optionally on the floor surfaces of the secondary ducts being provided with a pattern, the distributor plate having at least two regions in which the patterns of the surfaces differ from one another.

Also proposed is a method for producing a distributor plate, whereby a hydrophobic coating is first applied to a hydrophilic base plate, and then a layer of the hydrophobic coating is partially removed in different thicknesses such that the secondary ducts are created and, depending on the thickness of the removed layer, have a hydrophobic secondary duct surface or hydrophilic secondary duct surface. In this context, the terms hydrophobic and hydrophilic are in particular understood to mean that the coating in this case has more hydrophobic surface properties than the base plate, and that the hydrophobic secondary duct surface has more hydrophobic surface properties than the hydrophilic secondary duct surface.

Further proposed is an electrochemical cell comprising the distributor plate, the distributor plate in particular being arranged in a cathode space of the electrochemical cell.

Further proposed is a method for operating the electrochemical cell, whereby a mixture having a first composition, in particular comprising oxygen, is fed into the distributor plate, and the mixture having a second composition, in particular comprising water, is discharged from the distributor plate, in which case the pattern varies depending on a local composition of the mixture. The composition of the mixture changes upon overflow of the distributor plate by the reaction taking place on the membrane.

Preferably, the electrochemical cell, which is preferably a fuel cell or an electrolyzer, preferably comprises at least the distributor plate, a gas diffusion layer, and a membrane or membrane-electrode arrangement. In particular, the gas diffusion layer is arranged between the distributor plate and the membrane.

The gas diffusion layer preferably has a porous structure and further preferably abuts the distributor plate under a high pressure of approximately 10 to 15 connecting portion. Preferably, the membrane is a polymer-electrolyte membrane having, for example, perfluorosulfonic acid (PFSA), in particular nafion, or consists of perfluorosulfonic acid (PFSA), in particular nafion. Furthermore, alkaline membranes can also be used.

Preferably, the gas diffusion layer comprises a nonwoven fabric, in particular a carbon fiber nonwoven fabric, and optionally a microporous layer, in which case the nonwoven fabric is arranged on a side of the gas diffusion layer facing the distributor plate. Further preferably, the gas diffusion layer consists of the carbon fiber nonwoven fabric and optionally the microporous layer. In the nonwoven fabric, the gas permeability in the thickness direction, i.e., in the direction of the membrane, can be comparable to the gas permeability in the plane, i.e., in directions parallel to the membrane.

The distributor plate preferably has carbon such as graphite, a metal such as stainless steel or titanium, and/or an alloy containing the metal. Further preferably, the distributor plate is constructed of carbon, metal, and/or alloy. In particular, a base plate of the distributor plate is made of carbon, the metal, and/or the alloy.

The secondary ducts can also be referred to as drainage ducts, capillary ducts, flutes, or as microscopically small, flute-like structures and serve to discharge resulting liquid reaction water from the connecting portions into the main ducts and into the main ducts, respectively. The secondary ducts are arranged in particular on one side of the distributor plate, which faces in the direction of an adjacently arranged gas diffusion layer in the electrochemical cell.

In addition, the pattern can have distributor ducts, in which case the distributor ducts have a respective larger diameter than the secondary ducts. The distributor ducts primarily serve to supply gas to the gas diffusion layer under the connecting portions of the bipolar plate and thus the electrode connected thereto, in particular the mixture containing oxygen. The distributor ducts guide the gas in particular to the regions where the gas diffusion layer rests on the connecting portions. The distributor ducts preferably connect two, in particular two adjacent, main ducts.

Preferably, the distributor ducts are each arranged at an angle to the main ducts. Preferably, the distributor ducts enclose a distributor angle of 20° to 70° with the main duct, further preferably 30° to 60°, in particular 30° to 45°. The distributor ducts have a cross-sectional surface area, which is preferably rectangular, triangular, or U-shaped. Preferably, a cross-sectional surface area of the main ducts is greater by at least a factor of fifty than a cross-sectional surface area of the distributor ducts. The distributor ducts can be arranged, for example, in a trapezoidal, undulating, parallel, cross-shaped, or honeycomb manner. The distributor ducts are preferably arranged on the side of the distributor plate facing in the direction of an adjacently arranged gas diffusion layer in the electrochemical cell, and in particular in contact regions.

The distributor plate, which can also be referred to as a bipolar plate, preferably has a wave-like structure, in which case connecting portions and main ducts alternate and are further preferably arranged parallel to one another.

Preferably, the surfaces of the connecting portions have a respective at least one contact region, which can also be referred to as a contact surface, against which the adjacently arranged gas diffusion layer abuts. Preferably, the contact regions of the connecting portions are arranged substantially parallel to the floor surfaces of the main ducts. Here, “substantially parallel” is to be understood in that a plane in which the contact regions lie and the floor surfaces enclose an angle of less than 30°, further preferably less than 20°, more preferably less than 10°, and in particular less than 5°.

Preferably, the secondary ducts are each arranged at least partially on the lateral surfaces. Preferably, the secondary ducts are arranged in the contact region and further preferably extend beyond the contact region at least onto the lateral surfaces.

The porous structure of the gas diffusion layer makes it difficult to naturally drain the water, which is typically present in liquid form at high current densities, so that water back-up can occur. This can limit the power density of the electrochemical cell in the contact regions.

Preferably, the connecting portions have lateral surfaces, which are in particular enclosed by the surfaces of the connecting portions. The surfaces of the connecting portions further preferably have two lateral surfaces per connecting portion, each connecting to a floor surface of the adjacent main duct. The lateral surfaces can also be referred to as flanks and are preferably arranged at a flank angle in relation to the floor surfaces, in which case the flank angle is further preferably in a range from 900 to 135°, more preferably in a range from 900 to 125°, in particular from 950 to 110°. Furthermore, the lateral surfaces are preferably arranged at an angle to the contact regions.

The main ducts are preferably arranged straight and further preferably parallel to one another on the distributor plate. The secondary ducts have a respective cross-sectional surface area, which is preferably triangular, i.e., V-shaped, round, square, or polygonal. Preferably, the cross-sectional surface area of the secondary ducts is V-shaped. The cross-sectional surface area can be constant over a length of the respective secondary duct, or it can change in size and/or geometry.

Preferably, a width and/or a depth of the secondary ducts is each from 1 μm to 150 m, further preferably from 1 μm to 100 μm, particularly preferably from 1 μm to 50 μm, more preferably from 1 μm to 10 μm, and most preferably 1 μm to 6 μm. Preferably, a distributor duct width and/or a distributor duct depth are each from 10 μm to 400 μm, further preferably the distributor duct width and/or the distributor duct depth are each greater than 50 μm and are in particular a maximum of 150 μm.

Preferably, the gas diffusion layer arranged adjacent to the distributor plate has fibers, and further preferably the width of the secondary ducts is less than a fiber diameter of the gas diffusion layer, for example about 8 am. The width of the secondary ducts can also be greater than the fiber diameter of the gas diffusion layer. In particular the width, but also the depth, of the secondary ducts can be selected depending on a structure of the adjacent gas diffusion layer.

Furthermore, in particular the depth and the width or the diameter of the secondary ducts are selected such that the secondary ducts form a capillary effect, in particular with regard to water. The term “diameter” is in particular understood to mean the largest diameter of the cross-sectional surface area.

Preferably, the distributor plate at least partially has a coating. The coating can be more hydrophilic or more hydrophobic than a material of the base plate of the distributor plate. In particular, in order to lower the electrical contact resistance of the distributor plate, the coating can be applied to the surface of the connecting portions. Furthermore, the coating can completely cover the surface of the connecting portions and optionally also the main ducts, or it can be partially present.

The coating can be hydrophobic and, in particular, it can have a lotus effect. The term “hydrophobic” is preferably understood to mean that the wettability is poorer than the wettability of smooth-surface steel with water, more preferably that the contact angle with respect to water droplets is greater than 70°, in particular greater than 80°. The coating can in particular be present in the contact regions in order to lower the contact resistance here, for example. Furthermore, the coating can be present on the floor surfaces.

Preferably, the coating comprises carbon, such as soot or graphite, in particular carbon particles, and an in particular organic binder, for example resin and/or polyvinylidene fluoride (PVDF). The binder can be thermoplastic or thermosetting. The coating preferably has a layer thickness in a range from 1 nm to 200 μm, further preferably from 5 nm to 100 μm, particularly preferably in a range from 5 nm to 50 μm. In the contact regions of the connecting portions, a layer thickness of greater than 5 μm is preferably present. The layer thickness is preferably less than 1 μm on the lateral surfaces and the floor surfaces.

Furthermore, the distributor plate can at least partially have a hydrophilic coating. The term “hydrophilic” is preferably understood to mean that the wettability is better than the wettability of smooth-surface steel with water, more preferably that the contact angle with respect to water droplets is less than 40°, in particular less than 10°. Preferably, the secondary ducts at least partially have a hydrophilic secondary duct surface and can have the hydrophilic coating so that water is drawn into the secondary ducts. The coating can also have an internal pattern, and the secondary ducts can be formed by the internal pattern. Preferably, the internal pattern is hydrophilic so that water is drawn into the internal pattern, like into a wick.

Furthermore, the lateral surface of the connecting portions and the floor surface of the main ducts can be hydrophilic or can have the hydrophilic coating, which serves to discharge water.

The contact region of the connecting portions can be hydrophobic or hydrophilic. If the contact region is hydrophilic, the water will collect directly in the contact region, in particular by wetting and/or condensation, and is then transported via the secondary ducts into the main ducts. If the contact region is hydrophobic, the water will in particular move directly into the secondary ducts, for example on the lateral surface of the connecting portions, in particular at a convex edge between the contact region and the lateral surface, and condense there first and then be transported away into the in particular adjacent main duct.

The coating can have a hydrophilic component, for example, oxidized carbon particles having hydroxide, carbonyl, and/or carboxyl groups, with a polymeric binder, which is particularly applicable for carbon distributor plates. Preferably, the coating has a surface roughness Ra in a range from 0.1 to 10 μm, and further preferably a bulk peak-to-valley maximum distance of 0.1 μm to 20 μm, more preferably from 1 μm to 10 μm.

The coating can be applied, e.g., by laser sintering or by methods also used in order to apply a metal, ceramic, polymer, or mixtures thereof to the distributor plate in motifs. Another example of a coating method is spray coating.

Alternatively, a coating material, such as powder, could first be applied to the distributor plate, then it could be locally selectively removed from the contact regions, for example, and then a selective (laser) sintering method could be performed. Thus, for example, only the main ducts could be provided with the coating. The coating can occur selectively, e.g., through a mask and/or screen printing.

The coating can also be applied over a surface and subsequently removed in part, for example by laser methods or mechanical methods, so that the secondary ducts are exposed and in particular lateral walls of the secondary ducts are formed by the coating.

The secondary ducts and optionally also the distributor ducts can be introduced into the base plate of the distributor plate, which is in particular a sheet metal, and/or into the coating of the distributor plate. In the latter case, the layer thickness is preferably greater than 5 μm. The secondary ducts and optionally also the distributor ducts can be coated or uncoated.

Preferably, the distributor plate has an inlet region and an outlet region, each having a port structure. The inlet region and the outlet region are in particular present in addition to the at least two regions. Gases and/or liquids, in particular the mixture, can be fed to or discharged from the distributor plate due to the port structure of the inlet region and the outlet region. The at least two regions are in particular regions of an active surface of the distributor plate. Preferably, the active surface has a rectangular shape.

The distributor plate is thus preferably structured differently depending on the location, in particular with regard to a design of the secondary ducts on the distributor plate.

Within the at least two different ranges, there is typically a different media supply, i.e., a different distribution and composition of the mixture, so that the gas supply, moisture, temperature distribution, and power distribution over the entire distributor plate, in particular the active surface of the distributor plate, can vary greatly. At a current density of, for example, 1.5 A/cm² and an oxygen stoichiometry of approximately 2, there is an oxygen content of approximately 11 vol. % in the main ducts at the outlet, while only less than 3 vol. % oxygen is contained in the mixture underneath the connecting portions near the electrode. For example, 21 vol. % is present at the inlet.

Further preferably, the at least two regions are arranged one behind the other between the inlet region and the outlet region. Accordingly, the supplied mixture preferably flows from the inlet region through the at least two regions to the outlet region, in which case further preferably a first region is first overflown, followed by a second region. Preferably, the distributor plate has more than two regions in which the patterns of the surfaces differ from one another.

The differentiation of the various patterns in the different regions can be based on the presence or absence of secondary ducts, the design of the secondary ducts, and the presence or absence of one or more coatings.

Preferably, the patterns of the at least two regions differ in terms of a number of secondary ducts per surface, a geometry of the secondary ducts, and/or an arrangement of the secondary ducts. Further preferably, the number of secondary ducts per surface increases in the direction from the inlet region to the outlet region. In each individual region, the number of secondary ducts per region can be constant or variable. Preferably, the secondary ducts have a secondary surface, and in particular a ratio of secondary surface area per total surface area, relative to a respective region, increases in the direction from the inlet region in to the outlet region. The secondary ducts are used in particular for the removal of liquid water. In the vicinity of the outlet region, more liquid water is produced per surface than in the vicinity of the inlet region, so that preferably more secondary ducts are present where more liquid water is to be discharged.

The patterns of the at least two regions can alternatively or additionally differ in terms of a number of distributor ducts per surface, a geometry of the distributor ducts, and/or an arrangement of the distributor ducts. Furthermore, the coating, in particular with regard to the material or composition and thickness of the coating, can vary in the at least two regions.

Preferably, the pattern is uniform within each of the at least two regions.

Furthermore, the distributor plate can have at least one planar region without secondary ducts and/or distributor ducts. In one embodiment, at least one of the two regions is a planar region without any secondary ducts. Accordingly, there is no pattern in the at least one planar region. Preferably, the planar region is arranged closer to the inlet region without any secondary ducts than another one of the at least two regions having a pattern. Further preferably, the planar region is subsequent to the inlet region, in particular directly subsequent.

Preferably, at least a first region, a second region, and a third region are arranged one behind the other in the direction from the inlet region to the outlet region, in particular in the sequence indicated.

In one preferred embodiment, the distributor plate has exactly three regions. In the operation of the electrochemical cell, in the first range, which can also be referred to as the input range, dry conditions typically prevail. In the second range, which can also be referred to as the mid-range, variable conditions typically prevail where high temperatures and water production are possible. In the third region, which can also be referred to as the end region or the output region, a high humidity and a supersaturated mixture typically prevail, in which case water is usually condensed.

Preferably, in the first region, at least one of the secondary ducts opens into an end structure, in which case the at least one secondary duct in the end structure branches into at least two sub-ducts, and in particular the at least two sub-ducts have a respective smaller diameter than the at least one secondary duct. In particular, a respective size of the cross-sectional surface area of the at least two sub-ducts is smaller than a size of the cross-sectional surface area of the at least one secondary duct. The end structure can also be referred to as a finer structure or extension, effectively increasing the surface area of the liquid water so that removal and/or vaporization of the liquid water into the mixture conducted in the main duct can be improved. Further preferably, the end structure has at least three sub-ducts, in which case at least one sub-duct can branch into further, at least two further, sub-ducts. Preferably, the at least one secondary duct and at least one of the sub-ducts partially enclose an angle in a range from 20° to 70°, more preferably 30° to 60°, for example 45°. Furthermore, the at least two sub-ducts preferably terminate in an orientation substantially parallel to the at least one secondary duct. Preferably, the sub-ducts have a straight path between respective branch lines.

In the second region, the pattern preferably additionally comprises the distributor ducts.

Preferably, in the third region, at least one of the secondary ducts is arranged with a first part at a first angle in a range from 300 to 1500 in relation to the main ducts and is arranged with a second part at a second angle in a range of less than 450 in relation to the main ducts. Additionally or alternatively, at least one of the secondary ducts can have a respective end region in which the depth of the at least one secondary duct decreases in the direction of a closest main duct, in particular in a main flow direction, and/or the width of the at least one secondary duct increases in the direction of the closest main duct, in particular in the main flow direction. Further preferably, in the end region, the depth continuously decreases and/or the width continuously increases. In particular, the diameter of the at least one secondary duct increases in the end region. The phrase “in the direction of the closest main duct” is understood to mean a direction along the secondary duct from the connecting portion, in particular the contact region, to the end region. The end regions can also be referred to as debonding regions. In the end regions, water droplets are discharged from the secondary ducts into the main ducts and water droplets are debonded from the secondary ducts. Preferably, the end region of the at least one secondary duct is arranged on a lateral surface of the connecting portions or on a floor surface of the main ducts. The end region represents a transition between the at least one secondary duct and the substantially planar floor surface of the main ducts. Furthermore, in the third region, the patterns can additionally comprise the distributor ducts.

Preferably, the first part of the at least one secondary duct, which is located in particular the contact region, is arranged substantially orthogonally to the main ducts, in particular to the closest main duct. The term “substantially orthogonal” is understood to mean that the first angle is 600 to 120°, further preferably 800 to 100°, and more preferably 85° to 95°, for example 90°. Preferably, the second part of the respective secondary duct is arranged substantially parallel to the main ducts, in particular to at least one adjacent main duct. The term “substantially parallel” is understood to mean that the second angle is less than 30°, further preferably less than 20°, more preferably less than 10°, and particularly preferably less than 5°. Due to the arrangement in the second angle, the at least one secondary duct is aligned in the main flow direction from the mixture in the main ducts, in particular in the vicinity of the end regions.

Preferably, the secondary ducts have a respective curved path on at least the lateral surfaces of the connecting portions. Alternatively or additionally, the secondary ducts on the lateral surfaces can have a straight path with at least one, preferably more than one, change of direction, which can also be referred to as a kink. While the secondary ducts in the contact region run substantially orthogonally to the main ducts, in particular in front of the end region, preferably an adjustment of the direction of the secondary ducts to the direction of the main ducts occurs. Preferably, this adjustment is made on a curved track. In this context, a path direction of the secondary ducts changes from a path at the first angle to a path at the second angle relative to the main ducts. Preferably, the first portion of the at least one secondary duct has a respective straight path.

In the first region, the secondary ducts in the contact regions preferably have a hydrophobic secondary duct surface. Preferably, at least partially hydrophilic surface properties are present in the first region on the lateral surfaces and the floor surfaces.

In the second region, in particular in the contact region, the secondary ducts preferably have partially a hydrophobic secondary duct surface and partially a hydrophilic secondary duct surface. Further preferably, secondary ducts with a hydrophobic secondary duct surface and secondary ducts with a hydrophilic secondary duct surface are alternately arranged.

In the third region, in particular in the contact region, there are preferably more secondary ducts with a hydrophilic secondary duct surface than secondary ducts with a hydrophobic secondary duct surface.

In order to produce the secondary ducts with a hydrophilic secondary duct surface, the hydrophobic coating can first be applied, which is then removed along the secondary ducts so that the re-exposed hydrophilic surface of the base plate, for example having a steel surface, forms the secondary duct surface. Alternatively, the base plate can already have a secondary duct embossed in the base plate with a hydrophilic secondary duct surface. For the production of a secondary duct with a hydrophobic secondary duct surface, for example, a hydrophobic coating can first be applied, which is then removed partially but not with a complete layer thickness, so that a secondary duct is created without re-exposing the base plate.

In the first region, the pattern is preferably designed in view of a distribution of the mixture, in particular through hydrophobic surfaces, and optionally a vaporization of liquid water. In particular, the pattern in the first region favors the distribution of the mixture and optionally the vaporization of liquid water.

In the second region, the pattern is preferably designed in view of the vaporization of water and optionally a discharging of liquid water, in particular through hydrophilic surfaces. In particular, the pattern in the second region preferably favors the vaporization of water and optionally the discharging of liquid water.

In the third region, the pattern is preferably designed in view of the discharge of liquid water. In particular, the pattern in the third region favors the discharging of liquid water.

In particular in the cathode space, a dry mixture and little liquid water are present in the first region arranged in the vicinity of the inlet region. Accordingly, there are no or a few secondary ducts. If secondary ducts are present, the end region or the end structure in particular can be optimized for the vaporization of liquid water, in which case the end structures in particular allow for fan-like leakage of the secondary ducts. Accordingly, in the contact regions of the connecting portions, there are preferably secondary ducts with a hydrophobic secondary surface in order to achieve a better gas exchange. Preferably, in the main ducts there are hydrophilic surface properties and/or secondary ducts with hydrophilic secondary duct surfaces in order to promote drainage of any liquid water present.

In the second region, which is in particular arranged centrally on the distributor plate or between the first region and the third region, secondary ducts are preferably partially present. Simultaneously, distributor ducts are preferably present, which in particular serve to distribute the mixture evenly over the active surface and in particular in the contact regions. End regions or end structures of the secondary ducts are preferably optimized for the vaporization of liquid water. Optionally, the end regions or end structures can be optimized for the discharge of droplets of liquid water. Preferably, there are alternate hydrophilic secondary duct surfaces for the removal of liquid water and hydrophobic secondary duct surfaces for the transport of the in particular gaseous mixture.

In the third region, the formation of a large amount of liquid water is typically expected on the membrane, so that the large amount of liquid water must be discharged from the contact regions. Accordingly, in the third region, there are preferably more secondary ducts per surface area, in particular per unit region, than in the first region and the second region, in which case the secondary ducts are further preferably combined with distributor ducts for the distribution of the in particular gaseous mixture. The end structures or end regions of the secondary ducts are further preferably optimized for the removal of droplets of liquid water, in which case the secondary ducts are preferably curved such that a flow of the mixture in the main ducts can push the liquid water out of the secondary ducts. Preferably, the secondary ducts are shaped at their ends corresponding to the end region and have a corresponding cross-sectional design, in particular a flare, so that a wide, flat debonding region is created in which the flow of the mixture is provided with sufficient water surface in order to form water droplets. In this context, the presence of the hydrophilic coating and/or the hydrophobic coating can provide further assistance in order to transfer water from the secondary ducts into the debonding region or end region and then promote droplet formation there. The coating can be similar to that of the second region, in which case preferably having more hydrophilic secondary surfaces for water removal and fewer hydrophobic secondary surfaces for gas transport are present in the third region.

By varying the patterns in different regions of the distributor plate, the flow behavior can be adjusted to the local reaction conditions such that, e.g., first the oxygen supply and then the water discharge in a fuel cell can be promoted. Accordingly, the locally different conditions and requirements within the active surface of the electrochemical cell are taken into account. Due to the differently patterned regions, which can also be differently coated, the water discharge and gas supply are optimized according to the locally present conditions in the individual regions.

Due to a curved path of the secondary ducts, the secondary ducts in the contact regions have a direction approximately perpendicular to the main flow direction of the main ducts, so that short transport paths for liquid water are available there. In the debonding region for water droplets in the main ducts, on the other hand, the secondary ducts have a path approximately parallel to the main flow direction due to the curvature, so that the debonding of water droplets from the secondary ducts is supported.

Through the end regions, a widening of the secondary ducts is achieved at their end, so that the mixture flow in the main ducts can more easily blow the liquid water out of the secondary ducts and drain as droplets. A coating, in particular the described division of hydrophilic and hydrophobic coating, can further improve the debonding of the water droplets.

### BRIEF DESCRIPTION OF THE DRAWINGS

Embodiments of the invention are explained in further detail with reference to the drawings and the following description.

Shown are:

FIG. 1 a schematic illustration of an electrochemical cell according to the prior art,

FIG. 2 a fuel cell setup with distributor plate,

FIG. 3 a contact region between a gas diffusion layer and a distributor plate,

FIG. 4 a detail of a distributor plate with secondary ducts within distributor ducts,

FIG. 5 a sectional view along a first sectional plane,

FIG. 6 a sectional view along a second sectional plane,

FIG. 7 a detail of a distributor plate with secondary ducts and end structure,

FIG. 8 a further embodiment of an end structure,

FIG. 9 yet another embodiment of an end structure,

FIG. 10 a detail of a distributor plate with secondary ducts and further secondary ducts,

FIG. 11 a detail of a distributor plate with secondary ducts with a curved path,

FIG. 12 an end region of a secondary duct,

FIG. 13 a plan view of a distributor plate with at least two regions, and

FIG. 14 an embodiment of a second region of a distributor plate.

### DETAILED DESCRIPTION

In the following description of the embodiments of the invention, identical or similar elements are denoted by identical reference signs, in which case a repeated description of these elements is omitted in individual cases. The drawings illustrate the subject matter of the invention in a schematic manner only.

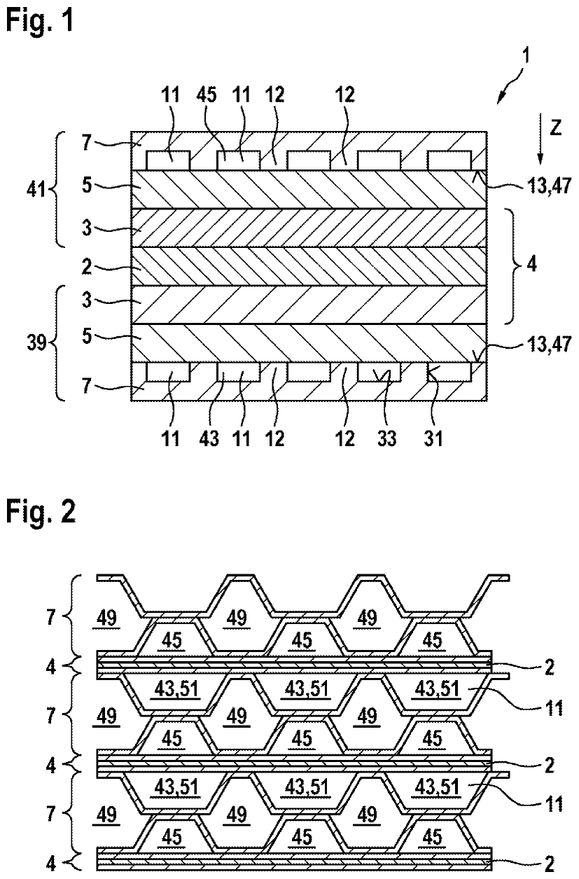

FIG. 1 schematically shows an electrochemical cell 1 in the form of a fuel cell according to the prior art. The electrochemical cell 1 has a membrane 2 as electrolytes. The membrane 2 separates a cathode space 39 from an anode space 41.

A respective electrode layer 3, a gas diffusion layer 5, and a distributor plate 7 are arranged on the membrane 2 in the cathode space 39 and anode space 41. The connection of the membrane 2 and the electrode layer 3 can also be referred to as a membrane-electrode assembly 4.

The distributor plates 7 have main ducts 11 for gas supply, for example of oxygen 43 in the cathode space 39 and hydrogen 45 in the anode space 41, to the gas diffusion layers 5. Main ducts 11 and connecting portions 12 alternate on the distributor plates 7.

On a surface 13 of the connecting portions 12, a respective contact region 47 is formed between the distributor plate 7 and the adjacently arranged gas diffusion layer 5. Furthermore, the connecting portions 12 have lateral surfaces 31 and the main ducts 11 have floor surfaces 33.

FIG. 2 shows a fuel cell setup comprising a plurality of distributor plates 7 and membrane electrode assemblies 4 having membranes 2. Oxygen 43, or air in which oxygen 43 is contained, and hydrogen 45 are conducted to the membrane-electrode assemblies 4 through the distributor plates 7. Water 51 is discharged in the main ducts 11 of the distributor plates 7 in which oxygen 43, or air in which oxygen 43 is contained, is supplied. In addition, the distributor plates 7 serve to guide a coolant 49.

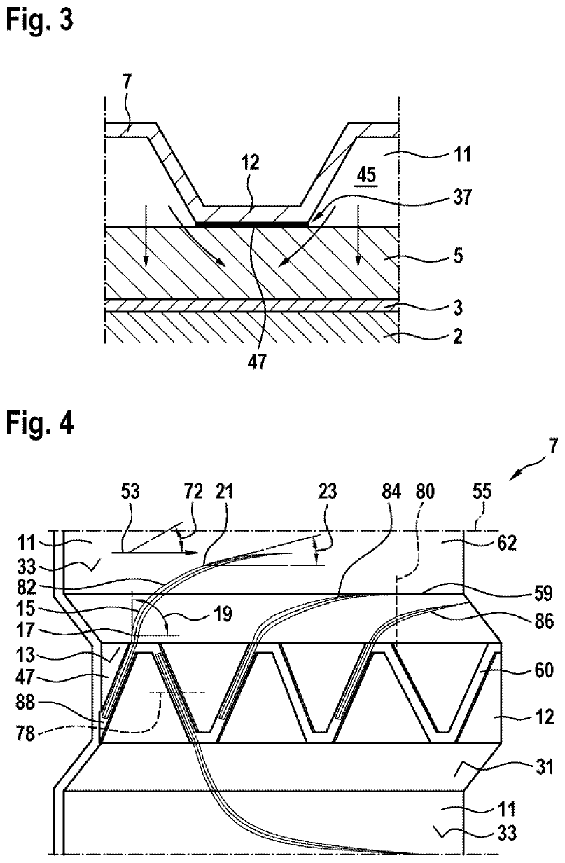

FIG. 3 shows a contact region 47 between a gas diffusion layer 5 and a distributor plate 7. A connecting portion 12 of the distributor plate 7 is in contact with the gas diffusion layer 5 here. Furthermore, a coating 37 is arranged on the connecting portion 12 of the distributor plate 7. Hydrogen 45 passes from the main ducts 11 through the gas diffusion layer 5 to the electrode layer 3, which is arranged on the membrane 2.

FIG. 4 shows a top perspective view of a detail of a distributor plate 7 with secondary ducts 15 partially arranged within the distributor ducts 60. The distributor plate 7 alternately has main ducts 11 and connecting portions 12. A main current direction 53 is present along the main ducts 11. Relative to the orientation of the main ducts 11, an assembly angle 72 is designated. Furthermore, the main ducts 11 have a respective axis of symmetry 55.

The connecting portions 12 have a respective surface 13, of which the parts arranged at an angle to the floor surfaces 33 of the main ducts 11 are referred to as lateral surfaces 31. Distributor ducts 60 are arranged in the contact region 47 of the surface 13 of the connecting portions 12. The floor surfaces 33 of the main ducts 11 connect to the lateral surfaces 31 of the connecting portions 12.

Four distributor ducts 60 have a respective secondary duct 15, which guides water 51 to an adjacent main duct 11 or to an adjacent lateral surface 31, and thus connects the respective distributor duct 60 to the main duct 11 or to the lateral surface 31.

The auxiliary ducts 15 each run partially in the distributor ducts 60, the auxiliary ducts 15 being arranged in a floor 88 of the distributor ducts 60. Accordingly, the secondary ducts 15 are arranged in part in the contact region 47 to a gas diffusion layer 5.

A first part 17 of each secondary duct 15 is arranged at a first angle 19 to the adjacent main duct 11 and a second part 21 of each secondary duct 15 is arranged at a second angle 23 to the adjacent main duct 11. The secondary ducts 15 shown in this case have a curvilinear profile, so that their arrangement changes relative to the neighboring main duct 11 with the profile. The secondary ducts 15 are respectively arranged on the distributor ducts 60 substantially perpendicular to the main duct 11 and arranged in the main duct 11 or in the vicinity of the main duct 11 substantially parallel to the main duct 11.

A first secondary duct 82 terminates on a planar part 62 of the floor surface 33 of the adjacent main duct 11. A second secondary duct 84 terminates at an edge 59 between the floor surface 33 of the main duct 11 and the lateral surface 31 of the connecting portion 12. A third secondary duct 86 terminates on the lateral surface 31 of the connecting portion 12 so that water 51 can drain from the lateral surface 31 onto the floor surface 33 of the adjacent main duct 11. Furthermore, a first cutting plane 78 and a second cutting plane 80 are marked.

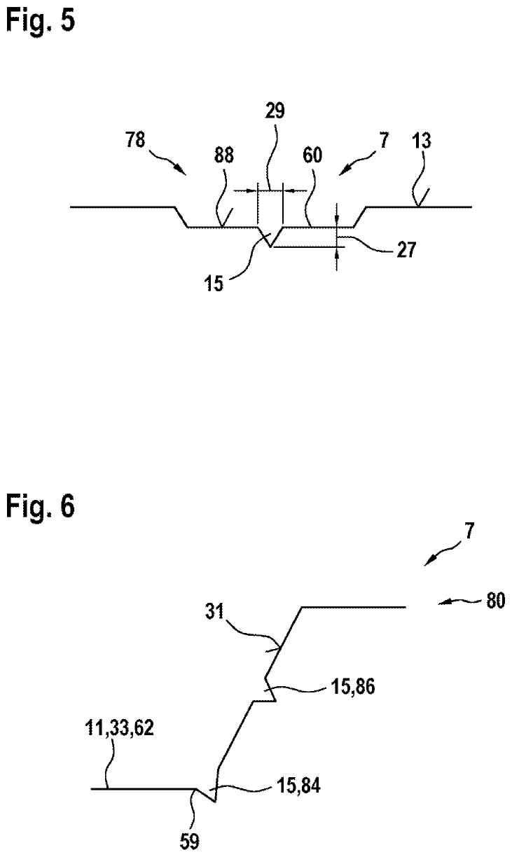

FIG. 5 shows a cross-sectional view along the first cross-sectional plane 78 shown in FIG. 4. Arranged in the surface 13 of the connecting portion 12 is the distributor duct 60 and arranged in the floor 88 of the distributor duct 60 is the secondary duct 15, which has a depth 27 and a width 29.

FIG. 6 shows a cross-sectional view along the second cross-sectional plane 80 shown in FIG. 4. The second secondary duct 84 is arranged at the edge 59 between the lateral surface 31 and the floor surface 33. The third secondary duct 86 is located in the lateral surface 31 of the connecting portion 12.

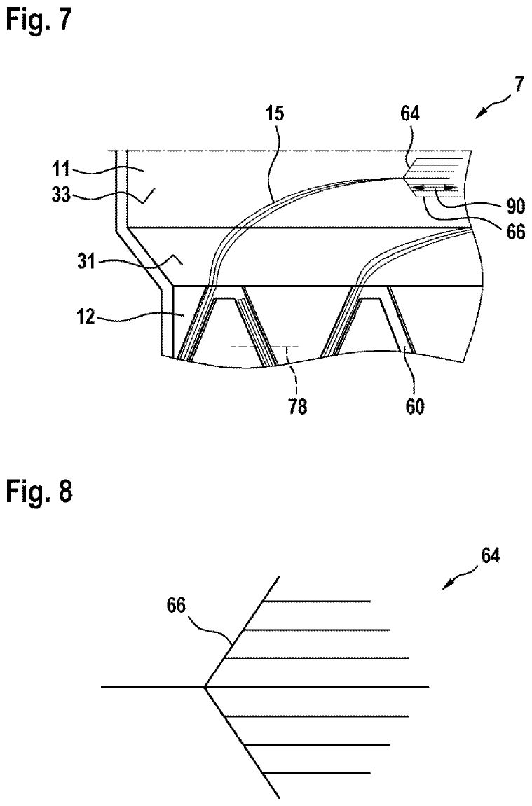

FIG. 7 shows a top perspective view of a detail of a distributor plate 7 having a distributor duct 60 that opens into an end structure 64 with more than two sub-ducts 66. A plurality of sub-ducts 66 are present, each having a same length 90 but being arranged offset from one another. The end structure 64 is arranged on the floor surface 33 of the main duct 11.

FIG. 8 shows a further embodiment of an end structure 64, with the sub-ducts 66 each having different lengths 90 and the length 90 within the end structure 64 decreasing from inward to outward.

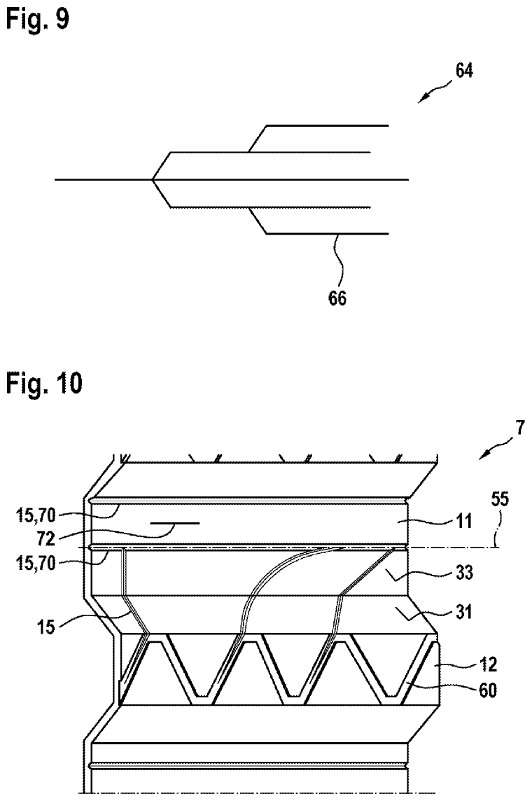

FIG. 9 shows yet another embodiment of an end structure 64 with sub-ducts 66, the sub-ducts 66 being arranged in groups offset from one another.

FIG. 10 shows a top perspective view of a detail of a distributor plate 7 with distributor ducts 60, secondary ducts 15 and further secondary ducts 70. The secondary ducts 15 are partially arranged within the distributor ducts 60 and all open up into a further secondary duct 70, which is arranged along an axis of symmetry 55 of the main duct 11. The arrangement angle 72 of the further secondary ducts 70 is 0° in the illustrated embodiment, and correspondingly the further secondary ducts 70 run parallel to the main duct 11. Furthermore, the width 29 and depth 27 of the secondary ducts 15 in the distributor ducts 60 increase in the discharge direction.

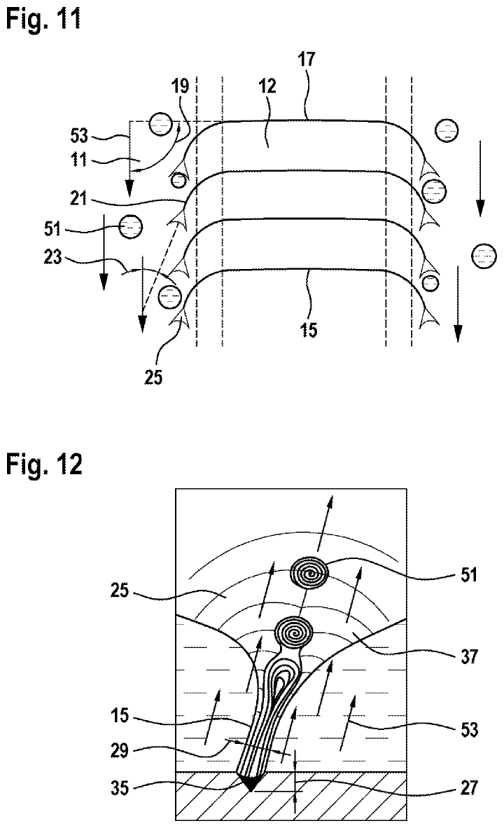

FIG. 11 shows a top plan view of a detail of a distributor plate 7 with secondary ducts 15, which have a curved profile at the transition from a first part 17 to a second part 21 of the secondary ducts 15.

The first part 17 of the secondary ducts 15 is respectively arranged at a first angle 19 to the main ducts 11 having a main flow direction 53. The second part 21 of the secondary ducts 15 is respectively arranged at a second angle 23 to the main ducts 11 and the main flow direction 53.

Furthermore, the secondary ducts 15 have end regions 25 that open into the main ducts 11 so that droplets of water 51 from the secondary ducts 15 debond into the main ducts 11.

FIG. 12 shows an end region 25 of a secondary duct 15. In the illustrated embodiment, the secondary duct 15 has a V-shaped cross-sectional surface area 35. The secondary duct 15 has a depth 27 which decreases in the end region 25 and a width 29 which increases in the end region 25. Due to the altered geometry of the secondary duct 15 in the end region 25, water 51 logged in the secondary duct 15 in the form of droplets from the secondary duct 15 debonds and is carried along in the main flow direction 53 of the main duct 11. The end region 25 can have a coating 37.

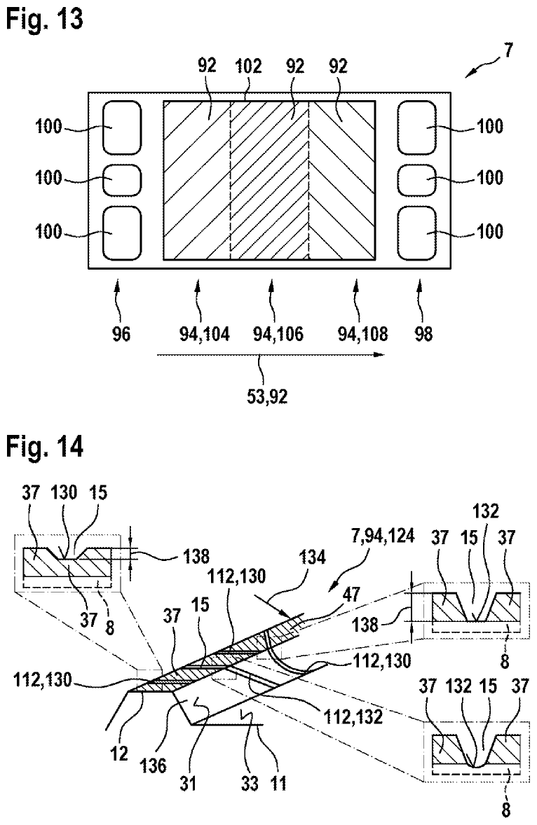

FIG. 13 shows a plan view of a distributor plate 7 having three regions 94 in which a pattern 92 of the surfaces 13 of the connecting portions 12 each differs from one another.

The distributor plate 7 shown has an inlet region 96 with port structures 100, a first region 104, a second region 106, a third region 108, and an outlet region 98, also with port structures 100, in a main flow direction 53 of a mixture 42 one behind the other. Together, the three regions 94 represent an active surface 102 of the distributor plate 7. The patterns 92 in the regions 94 are respectively adjusted to the local reaction conditions, because a content of oxygen 43 in the mixture 42 decreases in the main flow direction 53 while a content of water 51 and thus a proportion of liquid in the mixture 42 increases.

FIG. 14 shows a detail of a second, i.e. center, region 124 of a distributor plate 7. The connecting portion 12 has a coating 37 in a contact region 47, in which case the coating 37 has hydrophobic surface properties 134. Conversely, a lateral surface 31 of the connecting portion 12 and a floor surface 33 of an adjacent main duct 11 have hydrophilic surface properties 136. A plurality of secondary ducts 15 are arranged in the contact region 47 of the connecting portion 12, secondary ducts 15 having a hydrophobic secondary duct surface 130 being arranged so as to alternate with secondary ducts 15 having a hydrophilic secondary duct surface 132. The secondary ducts 15 with the hydrophilic secondary duct surface 132 extend from the contact region 47 to the lateral surface 31.

The hydrophobic secondary duct surfaces 130 were created by applying a hydrophobic coating 37 to a hydrophilic base plate 8 and only partially removing the hydrophobic coating 37 again, thus forming the secondary duct 15. A thickness 138 of the hydrophobic coating 37 has been removed again.

The hydrophilic secondary duct surfaces 132 were formed by applying the hydrophobic coating 37 to the hydrophilic base plate 8 and then locally completely removing the hydrophobic coating 37 again, such that portions of the hydrophilic base plate 8 are exposed and form the hydrophilic secondary duct surface 132. To form the hydrophilic secondary duct surfaces 132, only the hydrophobic coating 37 can be removed again, or an embossing can also be continued into the hydrophilic base plate 8 in order to create a deeper secondary duct 15.

The invention is not limited to the exemplary embodiments described herein and the aspects emphasized thereby. Rather, a variety of modifications within the scope of activities of a skilled person is possible within the range specified by the claims.

### Distributor Plate for an Electrochemical Cell, Method for Producing the Distributor Plate, Electrochemical Cell, and Method for Operating the Electrochemical Cell

The invention relates to a distributor plate for an electrochemical cell, the distributor plate having a structure comprising connecting portions with surfaces and main ducts having floor surfaces. The invention further relates to a method for producing the distributor plate, an electrochemical cell comprising the distributor plate, and a method for operating the electrochemical cell.

Electrochemical cells are electrochemical energy transducers and are known in the form of fuel cells or electrolyzers.

A fuel cell converts the chemical reaction energy of a continuously supplied fuel and an oxidizing agent into electrical energy. In known fuel cells, hydrogen (H₂) and oxygen (02) are in particular converted to water (H₂O), electrical energy, and heat.

Proton-exchange membrane (PEM) fuel cells are known, among others. Proton-exchange membrane fuel cells comprise a centrally arranged membrane that is permeable to protons, i.e. hydrogen ions. The oxidizing agent, in particular atmospheric oxygen, is thereby spatially separated from the fuel, in particular hydrogen.

Fuel cells comprise an anode and a cathode. The fuel is supplied to the fuel cell at the anode and catalytically oxidized with loss of electrons to form protons that reach the cathode. The lost electrons are discharged from the fuel cell and flow via an external circuit to the cathode.

The oxidizing agent, in particular atmospheric oxygen, is supplied to the fuel cell at the cathode and reacts to form water by receiving the electrons from the external circuit and protons. The resulting water is drained from the fuel cell. The gross reaction is:

O₂+4H⁺+4e⁻→2H₂O

A voltage is in this case applied between the anode and the cathode of the fuel cell. In order to increase the voltage, a plurality of fuel cells can be mechanically arranged one behind the other to form a fuel cell stack, which can also be referred to as a fuel cell system, and can be electrically connected in series.

A stack of electrochemical cells typically has end plates that press the individual cells together and impart a stability onto the stack. The end plates can also serve as a positive or negative pole of the stack for discharging the current.

The electrodes, i.e. the anode and the cathode, and the membrane can be structurally assembled to form a membrane-electrode assembly (MEA).

Stacks of electrochemical cells further have bipolar plates, also referred to as gas distributor plates or distributor plates. Bipolar plates serve to distribute the fuel evenly to the anode and to distribute the oxidizing agent evenly to the cathode. Furthermore, bipolar plates usually have a surface structure, in particular duct-like structures, for distributing the fuel and the oxidizing agent to the electrodes. In particular in fuel cells, the duct-like structures also serve to drain the water produced during the reaction. In addition, the bipolar plates can comprise structures for passing a cooling medium through the electrochemical cell in order to discharge heat.

In addition to the media guidance with respect to oxygen, hydrogen, and water, the bipolar plates ensure a planar electrical contact to the membrane.

For example, a fuel cell stack typically comprises up to a few hundred individual fuel cells stacked one on top of the other in layers as so-called sandwiches. The individual fuel cells comprise one MEA and a bipolar plate half on both the anode side and the cathode side. In particular, a fuel cell comprises an anode monopolar plate and a cathode monopolar plate, typically each in the form of embossed sheets, which together form the bipolar plate and thus form ducts for guiding gas and liquids, between which the cooling medium flows.

Furthermore, electrochemical cells typically comprise gas diffusion layers for gas distribution. The gas diffusion layers are arranged between a bipolar plate and a MEA and are typically constructed on the duct side, i.e., in the direction of the adjacent bipolar plate, from a carbon fiber nonwoven fabric, which is also referred to as “gas diffusion backing” (GDB), and on the catalyst side, i.e., in the direction of the membrane, from a microporous layer, which is also referred to as “micro porous layer” (MPL).

In contrast to a fuel cell, an electrolyzer is an energy converter, which, while applying electrical voltage, preferably splits water into hydrogen and oxygen. Electrolyzers also have MEAs, bipolar plates, and gas diffusion layers, among other things.

For the efficiency of an electrochemical cell, in particular with a polymer electrolyte membrane, it is particularly important to homogeneously supply reaction gas to the electrode layers arranged on the membrane.

Known distributor plates in particular have ducts and respectively abutting or adjacent connecting portions that form a structure. The ducts are also referred to as main ducts or ducts and the connecting portions can be called lands. Surfaces of the connecting portions at least partially parallel to the extension plane of the distributor plate comprise contact surfaces of the distributor plate to an adjacent gas diffusion layer of the electrochemical cell. Gaseous hydrogen and oxygen pass the gas diffusion layer from the ducts of the distributor plate to the reaction zone on the membrane. The regions of the gas diffusion layer, which rest on the connecting portions of the distributor plate and thus the corresponding regions of the underlying MEA, are supplied comparatively poorly with reaction gas, in particular under flooding conditions of the electrochemical cell, which can lead to an undesirable inhomogeneous current density distribution.

On the side of the membrane at which air, i.e. oxygen, is supplied, water is produced in the operation of the fuel cell, which must be transported through the gas diffusion layer to the ducts of the distributor plate and removed from the cell there. Typical operating temperatures for electrochemical cells having a membrane are less than 120° C., so the water typically condenses in the gas diffusion layer and is present in liquid form. In the gas diffusion layer, the transport direction of the water is opposite to the transport direction of the gas, and accumulated water can severely impede the feeding of reaction gas, in particular oxygen.

The higher the power density of the electrochemical cell, the more water is produced, so the discharge of the amounts of liquid water in the contact region between the gas diffusion layer and air duct side of the distributor plates may be insufficient.

JP 2020-47441 A describes an improved drainage system for bipolar plates in which additional flutes are provided in flanks of the connecting portions parallel to the direction of the main ducts. JP 2020-47443 A describes bipolar plates with improved water drainage, wherein connecting portions of the bipolar plates have an additional duct system arranged transversely to the direction of the main ducts. Each of two ducts of the additional duct system has a common drain. Furthermore, transverse structures in main ducts of a distributor plate, leading to high pressure loss, are disclosed.

JP 2020-47440 A also relates to bipolar plates with an improved drainage system, wherein the connecting portions have notches transverse to the direction of the main ducts and additional flutes along the flanks of the connecting portions parallel to the direction of the main ducts.

### DISCLOSURE OF THE INVENTION

A distributor plate for an electrochemical cell is proposed, the distributor plate having a structure comprising connecting portions with surfaces and main ducts having floor surfaces, the surfaces and optionally on the floor surfaces of the secondary ducts being provided with a pattern, the distributor plate having at least two regions in which the patterns of the surfaces differ from one another.

Also proposed is a method for producing a distributor plate, whereby a hydrophobic coating is first applied to a hydrophilic base plate, and then a layer of the hydrophobic coating is partially removed in different thicknesses such that the secondary ducts are created and, depending on the thickness of the removed layer, have a hydrophobic secondary duct surface or hydrophilic secondary duct surface. In this context, the terms hydrophobic and hydrophilic are in particular understood to mean that the coating in this case has more hydrophobic surface properties than the base plate, and that the hydrophobic secondary duct surface has more hydrophobic surface properties than the hydrophilic secondary duct surface.

Further proposed is an electrochemical cell comprising the distributor plate, the distributor plate in particular being arranged in a cathode space of the electrochemical cell.

Further proposed is a method for operating the electrochemical cell, whereby a mixture having a first composition, in particular comprising oxygen, is fed into the distributor plate, and the mixture having a second composition, in particular comprising water, is discharged from the distributor plate, in which case the pattern varies depending on a local composition of the mixture. The composition of the mixture changes upon overflow of the distributor plate by the reaction taking place on the membrane.

Preferably, the electrochemical cell, which is preferably a fuel cell or an electrolyzer, preferably comprises at least the distributor plate, a gas diffusion layer, and a membrane or membrane-electrode arrangement. In particular, the gas diffusion layer is arranged between the distributor plate and the membrane.

The gas diffusion layer preferably has a porous structure and further preferably abuts the distributor plate under a high pressure of approximately 10 to 15 connecting portion. Preferably, the membrane is a polymer-electrolyte membrane having, for example, perfluorosulfonic acid (PFSA), in particular nafion, or consists of perfluorosulfonic acid (PFSA), in particular nafion. Furthermore, alkaline membranes can also be used.

Preferably, the gas diffusion layer comprises a nonwoven fabric, in particular a carbon fiber nonwoven fabric, and optionally a microporous layer, in which case the nonwoven fabric is arranged on a side of the gas diffusion layer facing the distributor plate. Further preferably, the gas diffusion layer consists of the carbon fiber nonwoven fabric and optionally the microporous layer. In the nonwoven fabric, the gas permeability in the thickness direction, i.e., in the direction of the membrane, can be comparable to the gas permeability in the plane, i.e., in directions parallel to the membrane.

The distributor plate preferably has carbon such as graphite, a metal such as stainless steel or titanium, and/or an alloy containing the metal. Further preferably, the distributor plate is constructed of carbon, metal, and/or alloy. In particular, a base plate of the distributor plate is made of carbon, the metal, and/or the alloy.

The secondary ducts can also be referred to as drainage ducts, capillary ducts, flutes, or as microscopically small, flute-like structures and serve to discharge resulting liquid reaction water from the connecting portions into the main ducts and into the main ducts, respectively. The secondary ducts are arranged in particular on one side of the distributor plate, which faces in the direction of an adjacently arranged gas diffusion layer in the electrochemical cell. In addition, the pattern can have distributor ducts, in which case the distributor ducts have a respective larger diameter than the secondary ducts. The distributor ducts primarily serve to supply gas to the gas diffusion layer under the connecting portions of the bipolar plate and thus the electrode connected thereto, in particular the mixture containing oxygen. The distributor ducts guide the gas in particular to the regions where the gas diffusion layer rests on the connecting portions. The distributor ducts preferably connect two, in particular two adjacent, main ducts.

Preferably, the distributor ducts are each arranged at an angle to the main ducts. Preferably, the distributor ducts enclose a distributor angle of 20° to 70° with the main duct, further preferably 30° to 60°, in particular 30° to 45°. The distributor ducts have a cross-sectional surface area, which is preferably rectangular, triangular, or U-shaped. Preferably, a cross-sectional surface area of the main ducts is greater by at least a factor of fifty than a cross-sectional surface area of the distributor ducts. The distributor ducts can be arranged, for example, in a trapezoidal, undulating, parallel, cross-shaped, or honeycomb manner. The distributor ducts are preferably arranged on the side of the distributor plate facing in the direction of an adjacently arranged gas diffusion layer in the electrochemical cell, and in particular in contact regions.

The distributor plate, which can also be referred to as a bipolar plate, preferably has a wave-like structure, in which case connecting portions and main ducts alternate and are further preferably arranged parallel to one another.

Preferably, the surfaces of the connecting portions have a respective at least one contact region, which can also be referred to as a contact surface, against which the adjacently arranged gas diffusion layer abuts. Preferably, the contact regions of the connecting portions are arranged substantially parallel to the floor surfaces of the main ducts. Here, “substantially parallel” is to be understood in that a plane in which the contact regions lie and the floor surfaces enclose an angle of less than 30°, further preferably less than 20°, more preferably less than 10°, and in particular less than 50.

Preferably, the secondary ducts are each arranged at least partially on the lateral surfaces. Preferably, the secondary ducts are arranged in the contact region and further preferably extend beyond the contact region at least onto the lateral surfaces.

The porous structure of the gas diffusion layer makes it difficult to naturally drain the water, which is typically present in liquid form at high current densities, so that water back-up can occur. This can limit the power density of the electrochemical cell in the contact regions.

Preferably, the connecting portions have lateral surfaces, which are in particular enclosed by the surfaces of the connecting portions. The surfaces of the connecting portions further preferably have two lateral surfaces per connecting portion, each connecting to a floor surface of the adjacent main duct. The lateral surfaces can also be referred to as flanks and are preferably arranged at a flank angle in relation to the floor surfaces, in which case the flank angle is further preferably in a range from 900 to 135°, more preferably in a range from 900 to 125°, in particular from 950 to 110°. Furthermore, the lateral surfaces are preferably arranged at an angle to the contact regions.

The main ducts are preferably arranged straight and further preferably parallel to one another on the distributor plate. The secondary ducts have a respective cross-sectional surface area, which is preferably triangular, i.e., V-shaped, round, square, or polygonal. Preferably, the cross-sectional surface area of the secondary ducts is V-shaped. The cross-sectional surface area can be constant over a length of the respective secondary duct, or it can change in size and/or geometry.

Preferably, a width and/or a depth of the secondary ducts is each from 1 μm to 150 μm, further preferably from 1 μm to 100 μm, particularly preferably from 1 μm to 50 μm, more preferably from 1 μm to 10 μm, and most preferably 1 μm to 6 μm. Preferably, a distributor duct width and/or a distributor duct depth are each from 10 μm to 400 μm, further preferably the distributor duct width and/or the distributor duct depth are each greater than 50 μm and are in particular a maximum of 150 μm.

Preferably, the gas diffusion layer arranged adjacent to the distributor plate has fibers, and further preferably the width of the secondary ducts is less than a fiber diameter of the gas diffusion layer, for example about 8 μm. The width of the secondary ducts can also be greater than the fiber diameter of the gas diffusion layer. In particular the width, but also the depth, of the secondary ducts can be selected depending on a structure of the adjacent gas diffusion layer.

Furthermore, in particular the depth and the width or the diameter of the secondary ducts are selected such that the secondary ducts form a capillary effect, in particular with regard to water. The term “diameter” is in particular understood to mean the largest diameter of the cross-sectional surface area.

Preferably, the distributor plate at least partially has a coating. The coating can be more hydrophilic or more hydrophobic than a material of the base plate of the distributor plate. In particular, in order to lower the electrical contact resistance of the distributor plate, the coating can be applied to the surface of the connecting portions. Furthermore, the coating can completely cover the surface of the connecting portions and optionally also the main ducts, or it can be partially present.

The coating can be hydrophobic and, in particular, it can have a lotus effect. The term “hydrophobic” is preferably understood to mean that the wettability is poorer than the wettability of smooth-surface steel with water, more preferably that the contact angle with respect to water droplets is greater than 70°, in particular greater than 80°. The coating can in particular be present in the contact regions in order to lower the contact resistance here, for example. Furthermore, the coating can be present on the floor surfaces.

Preferably, the coating comprises carbon, such as soot or graphite, in particular carbon particles, and an in particular organic binder, for example resin and/or polyvinylidene fluoride (PVDF). The binder can be thermoplastic or thermosetting. The coating preferably has a layer thickness in a range from 1 nm to 200 μm, further preferably from 5 nm to 100 μm, particularly preferably in a range from 5 nm to 50 μm. In the contact regions of the connecting portions, a layer thickness of greater than 5 μm is preferably present. The layer thickness is preferably less than 1 μm on the lateral surfaces and the floor surfaces.

Furthermore, the distributor plate can at least partially have a hydrophilic coating. The term “hydrophilic” is preferably understood to mean that the wettability is better than the wettability of smooth-surface steel with water, more preferably that the contact angle with respect to water droplets is less than 40°, in particular less than 10°. Preferably, the secondary ducts at least partially have a hydrophilic secondary duct surface and can have the hydrophilic coating so that water is drawn into the secondary ducts. The coating can also have an internal pattern, and the secondary ducts can be formed by the internal pattern. Preferably, the internal pattern is hydrophilic so that water is drawn into the internal pattern, like into a wick.

Furthermore, the lateral surface of the connecting portions and the floor surface of the main ducts can be hydrophilic or can have the hydrophilic coating, which serves to discharge water.

The contact region of the connecting portions can be hydrophobic or hydrophilic. If the contact region is hydrophilic, the water will collect directly in the contact region, in particular by wetting and/or condensation, and is then transported via the secondary ducts into the main ducts. If the contact region is hydrophobic, the water will in particular move directly into the secondary ducts, for example on the lateral surface of the connecting portions, in particular at a convex edge between the contact region and the lateral surface, and condense there first and then be transported away into the in particular adjacent main duct.

The coating can have a hydrophilic component, for example, oxidized carbon particles having hydroxide, carbonyl, and/or carboxyl groups, with a polymeric binder, which is particularly applicable for carbon distributor plates. Preferably, the coating has a surface roughness Ra in a range from 0.1 to 10 μm, and further preferably a bulk peak-to-valley maximum distance of 0.1 m to 20 μm, more preferably from 1 μm to 10 μm.

The coating can be applied, e.g., by laser sintering or by methods also used in order to apply a metal, ceramic, polymer, or mixtures thereof to the distributor plate in motifs. Another example of a coating method is spray coating.

Alternatively, a coating material, such as powder, could first be applied to the distributor plate, then it could be locally selectively removed from the contact regions, for example, and then a selective (laser) sintering method could be performed. Thus, for example, only the main ducts could be provided with the coating. The coating can occur selectively, e.g., through a mask and/or screen printing.

The coating can also be applied over a surface and subsequently removed in part, for example by laser methods or mechanical methods, so that the secondary ducts are exposed and in particular lateral walls of the secondary ducts are formed by the coating.

The secondary ducts and optionally also the distributor ducts can be introduced into the base plate of the distributor plate, which is in particular a sheet metal, and/or into the coating of the distributor plate. In the latter case, the layer thickness is preferably greater than 5 μm. The secondary ducts and optionally also the distributor ducts can be coated or uncoated.

Preferably, the distributor plate has an inlet region and an outlet region, each having a port structure. The inlet region and the outlet region are in particular present in addition to the at least two regions. Gases and/or liquids, in particular the mixture, can be fed to or discharged from the distributor plate due to the port structure of the inlet region and the outlet region. The at least two regions are in particular regions of an active surface of the distributor plate. Preferably, the active surface has a rectangular shape.

The distributor plate is thus preferably structured differently depending on the location, in particular with regard to a design of the secondary ducts on the distributor plate.

Within the at least two different ranges, there is typically a different media supply, i.e., a different distribution and composition of the mixture, so that the gas supply, moisture, temperature distribution, and power distribution over the entire distributor plate, in particular the active surface of the distributor plate, can vary greatly. At a current density of, for example, 1.5 A/cm² and an oxygen stoichiometry of approximately 2, there is an oxygen content of approximately 11 vol. % in the main ducts at the outlet, while only less than 3 vol. % oxygen is contained in the mixture underneath the connecting portions near the electrode. For example, 21 vol. % is present at the inlet.

Further preferably, the at least two regions are arranged one behind the other between the inlet region and the outlet region. Accordingly, the supplied mixture preferably flows from the inlet region through the at least two regions to the outlet region, in which case further preferably a first region is first overflown, followed by a second region. Preferably, the distributor plate has more than two regions in which the patterns of the surfaces differ from one another.

The differentiation of the various patterns in the different regions can be based on the presence or absence of secondary ducts, the design of the secondary ducts, and the presence or absence of one or more coatings.

Preferably, the patterns of the at least two regions differ in terms of a number of secondary ducts per surface, a geometry of the secondary ducts, and/or an arrangement of the secondary ducts. Further preferably, the number of secondary ducts per surface increases in the direction from the inlet region to the outlet region. In each individual region, the number of secondary ducts per region can be constant or variable. Preferably, the secondary ducts have a secondary surface, and in particular a ratio of secondary surface area per total surface area, relative to a respective region, increases in the direction from the inlet region in to the outlet region. The secondary ducts are used in particular for the removal of liquid water. In the vicinity of the outlet region, more liquid water is produced per surface than in the vicinity of the inlet region, so that preferably more secondary ducts are present where more liquid water is to be discharged.

The patterns of the at least two regions can alternatively or additionally differ in terms of a number of distributor ducts per surface, a geometry of the distributor ducts, and/or an arrangement of the distributor ducts. Furthermore, the coating, in particular with regard to the material or composition and thickness of the coating, can vary in the at least two regions.

Preferably, the pattern is uniform within each of the at least two regions.

Furthermore, the distributor plate can have at least one planar region without secondary ducts and/or distributor ducts. In one embodiment, at least one of the two regions is a planar region without any secondary ducts. Accordingly, there is no pattern in the at least one planar region. Preferably, the planar region is arranged closer to the inlet region without any secondary ducts than another one of the at least two regions having a pattern. Further preferably, the planar region is subsequent to the inlet region, in particular directly subsequent.

Preferably, at least a first region, a second region, and a third region are arranged one behind the other in the direction from the inlet region to the outlet region, in particular in the sequence indicated.

In one preferred embodiment, the distributor plate has exactly three regions. In the operation of the electrochemical cell, in the first range, which can also be referred to as the input range, dry conditions typically prevail. In the second range, which can also be referred to as the mid-range, variable conditions typically prevail where high temperatures and water production are possible. In the third region, which can also be referred to as the end region or the output region, a high humidity and a supersaturated mixture typically prevail, in which case water is usually condensed.

Preferably, in the first region, at least one of the secondary ducts opens into an end structure, in which case the at least one secondary duct in the end structure branches into at least two sub-ducts, and in particular the at least two sub-ducts have a respective smaller diameter than the at least one secondary duct. In particular, a respective size of the cross-sectional surface area of the at least two sub-ducts is smaller than a size of the cross-sectional surface area of the at least one secondary duct. The end structure can also be referred to as a finer structure or extension, effectively increasing the surface area of the liquid water so that removal and/or vaporization of the liquid water into the mixture conducted in the main duct can be improved. Further preferably, the end structure has at least three sub-ducts, in which case at least one sub-duct can branch into further, at least two further, sub-ducts. Preferably, the at least one secondary duct and at least one of the sub-ducts partially enclose an angle in a range from 20° to 70°, more preferably 30° to 60°, for example 45°. Furthermore, the at least two sub-ducts preferably terminate in an orientation substantially parallel to the at least one secondary duct. Preferably, the sub-ducts have a straight path between respective branch lines.

In the second region, the pattern preferably additionally comprises the distributor ducts.

Preferably, in the third region, at least one of the secondary ducts is arranged with a first part at a first angle in a range from 300 to 1500 in relation to the main ducts and is arranged with a second part at a second angle in a range of less than 450 in relation to the main ducts. Additionally or alternatively, at least one of the secondary ducts can have a respective end region in which the depth of the at least one secondary duct decreases in the direction of a closest main duct, in particular in a main flow direction, and/or the width of the at least one secondary duct increases in the direction of the closest main duct, in particular in the main flow direction. Further preferably, in the end region, the depth continuously decreases and/or the width continuously increases. In particular, the diameter of the at least one secondary duct increases in the end region. The phrase “in the direction of the closest main duct” is understood to mean a direction along the secondary duct from the connecting portion, in particular the contact region, to the end region. The end regions can also be referred to as debonding regions. In the end regions, water droplets are discharged from the secondary ducts into the main ducts and water droplets are debonded from the secondary ducts. Preferably, the end region of the at least one secondary duct is arranged on a lateral surface of the connecting portions or on a floor surface of the main ducts. The end region represents a transition between the at least one secondary duct and the substantially planar floor surface of the main ducts. Furthermore, in the third region, the patterns can additionally comprise the distributor ducts.

Preferably, the first part of the at least one secondary duct, which is located in particular the contact region, is arranged substantially orthogonally to the main ducts, in particular to the closest main duct. The term “substantially orthogonal” is understood to mean that the first angle is 600 to 120°, further preferably 800 to 100°, and more preferably 85° to 95°, for example 90°. Preferably, the second part of the respective secondary duct is arranged substantially parallel to the main ducts, in particular to at least one adjacent main duct. The term “substantially parallel” is understood to mean that the second angle is less than 30°, further preferably less than 20°, more preferably less than 10°, and particularly preferably less than 5°. Due to the arrangement in the second angle, the at least one secondary duct is aligned in the main flow direction from the mixture in the main ducts, in particular in the vicinity of the end regions.

Preferably, the secondary ducts have a respective curved path on at least the lateral surfaces of the connecting portions. Alternatively or additionally, the secondary ducts on the lateral surfaces can have a straight path with at least one, preferably more than one, change of direction, which can also be referred to as a kink. While the secondary ducts in the contact region run substantially orthogonally to the main ducts, in particular in front of the end region, preferably an adjustment of the direction of the secondary ducts to the direction of the main ducts occurs. Preferably, this adjustment is made on a curved track. In this context, a path direction of the secondary ducts changes from a path at the first angle to a path at the second angle relative to the main ducts. Preferably, the first portion of the at least one secondary duct has a respective straight path.

In the first region, the secondary ducts in the contact regions preferably have a hydrophobic secondary duct surface. Preferably, at least partially hydrophilic surface properties are present in the first region on the lateral surfaces and the floor surfaces.

In the second region, in particular in the contact region, the secondary ducts preferably have partially a hydrophobic secondary duct surface and partially a hydrophilic secondary duct surface. Further preferably, secondary ducts with a hydrophobic secondary duct surface and secondary ducts with a hydrophilic secondary duct surface are alternately arranged.

In the third region, in particular in the contact region, there are preferably more secondary ducts with a hydrophilic secondary duct surface than secondary ducts with a hydrophobic secondary duct surface.

In order to produce the secondary ducts with a hydrophilic secondary duct surface, the hydrophobic coating can first be applied, which is then removed along the secondary ducts so that the re-exposed hydrophilic surface of the base plate, for example having a steel surface, forms the secondary duct surface. Alternatively, the base plate can already have a secondary duct embossed in the base plate with a hydrophilic secondary duct surface. For the production of a secondary duct with a hydrophobic secondary duct surface, for example, a hydrophobic coating can first be applied, which is then removed partially but not with a complete layer thickness, so that a secondary duct is created without re-exposing the base plate.

In the first region, the pattern is preferably designed in view of a distribution of the mixture, in particular through hydrophobic surfaces, and optionally a vaporization of liquid water. In particular, the pattern in the first region favors the distribution of the mixture and optionally the vaporization of liquid water.

In the second region, the pattern is preferably designed in view of the vaporization of water and optionally a discharging of liquid water, in particular through hydrophilic surfaces. In particular, the pattern in the second region preferably favors the vaporization of water and optionally the discharging of liquid water.

In the third region, the pattern is preferably designed in view of the discharge of liquid water. In particular, the pattern in the third region favors the discharging of liquid water.

In particular in the cathode space, a dry mixture and little liquid water are present in the first region arranged in the vicinity of the inlet region. Accordingly, there are no or a few secondary ducts. If secondary ducts are present, the end region or the end structure in particular can be optimized for the vaporization of liquid water, in which case the end structures in particular allow for fan-like leakage of the secondary ducts. Accordingly, in the contact regions of the connecting portions, there are preferably secondary ducts with a hydrophobic secondary surface in order to achieve a better gas exchange. Preferably, in the main ducts there are hydrophilic surface properties and/or secondary ducts with hydrophilic secondary duct surfaces in order to promote drainage of any liquid water present.

In the second region, which is in particular arranged centrally on the distributor plate or between the first region and the third region, secondary ducts are preferably partially present. Simultaneously, distributor ducts are preferably present, which in particular serve to distribute the mixture evenly over the active surface and in particular in the contact regions. End regions or end structures of the secondary ducts are preferably optimized for the vaporization of liquid water. Optionally, the end regions or end structures can be optimized for the discharge of droplets of liquid water. Preferably, there are alternate hydrophilic secondary duct surfaces for the removal of liquid water and hydrophobic secondary duct surfaces for the transport of the in particular gaseous mixture.

In the third region, the formation of a large amount of liquid water is typically expected on the membrane, so that the large amount of liquid water must be discharged from the contact regions. Accordingly, in the third region, there are preferably more secondary ducts per surface area, in particular per unit region, than in the first region and the second region, in which case the secondary ducts are further preferably combined with distributor ducts for the distribution of the in particular gaseous mixture. The end structures or end regions of the secondary ducts are further preferably optimized for the removal of droplets of liquid water, in which case the secondary ducts are preferably curved such that a flow of the mixture in the main ducts can push the liquid water out of the secondary ducts. Preferably, the secondary ducts are shaped at their ends corresponding to the end region and have a corresponding cross-sectional design, in particular a flare, so that a wide, flat debonding region is created in which the flow of the mixture is provided with sufficient water surface in order to form water droplets. In this context, the presence of the hydrophilic coating and/or the hydrophobic coating can provide further assistance in order to transfer water from the secondary ducts into the debonding region or end region and then promote droplet formation there. The coating can be similar to that of the second region, in which case preferably having more hydrophilic secondary surfaces for water removal and fewer hydrophobic secondary surfaces for gas transport are present in the third region.

### Advantages of the Invention

By varying the patterns in different regions of the distributor plate, the flow behavior can be adjusted to the local reaction conditions such that, e.g., first the oxygen supply and then the water discharge in a fuel cell can be promoted. Accordingly, the locally different conditions and requirements within the active surface of the electrochemical cell are taken into account. Due to the differently patterned regions, which can also be differently coated, the water discharge and gas supply are optimized according to the locally present conditions in the individual regions.

Due to a curved path of the secondary ducts, the secondary ducts in the contact regions have a direction approximately perpendicular to the main flow direction of the main ducts, so that short transport paths for liquid water are available there. In the debonding region for water droplets in the main ducts, on the other hand, the secondary ducts have a path approximately parallel to the main flow direction due to the curvature, so that the debonding of water droplets from the secondary ducts is supported.

Through the end regions, a widening of the secondary ducts is achieved at their end, so that the mixture flow in the main ducts can more easily blow the liquid water out of the secondary ducts and drain as droplets. A coating, in particular the described division of hydrophilic and hydrophobic coating, can further improve the debonding of the water droplets.

### BRIEF DESCRIPTION OF THE DRAWINGS

Embodiments of the invention are explained in further detail with reference to the drawings and the following description.

Shown are:

FIG. 1 a schematic illustration of an electrochemical cell according to the prior art,

FIG. 2 a fuel cell setup with distributor plate,

FIG. 3 a contact region between a gas diffusion layer and a distributor plate,

FIG. 4 a detail of a distributor plate with secondary ducts within distributor ducts,

FIG. 5 a sectional view along a first sectional plane,

FIG. 6 a sectional view along a second sectional plane,

FIG. 7 a detail of a distributor plate with secondary ducts and end structure,

FIG. 8 a further embodiment of an end structure,

FIG. 9 yet another embodiment of an end structure,

FIG. 10 a detail of a distributor plate with secondary ducts and further secondary ducts,

FIG. 11 a detail of a distributor plate with secondary ducts with a curved path,

FIG. 12 an end region of a secondary duct,

FIG. 13 a plan view of a distributor plate with at least two regions, and

FIG. 14 an embodiment of a second region of a distributor plate.

### Embodiments of the Invention

In the following description of the embodiments of the invention, identical or similar elements are denoted by identical reference signs, in which case a repeated description of these elements is omitted in individual cases. The drawings illustrate the subject matter of the invention in a schematic manner only.

FIG. 1 schematically shows an electrochemical cell 1 in the form of a fuel cell according to the prior art. The electrochemical cell 1 has a membrane 2 as electrolytes. The membrane 2 separates a cathode space 39 from an anode space 41.

A respective electrode layer 3, a gas diffusion layer 5, and a distributor plate 7 are arranged on the membrane 2 in the cathode space 39 and anode space 41. The connection of the membrane 2 and the electrode layer 3 can also be referred to as a membrane-electrode assembly 4.

The distributor plates 7 have main ducts 11 for gas supply, for example of oxygen 43 in the cathode space 39 and hydrogen 45 in the anode space 41, to the gas diffusion layers 5. Main ducts 11 and connecting portions 12 alternate on the distributor plates 7.

On a surface 13 of the connecting portions 12, a respective contact region 47 is formed between the distributor plate 7 and the adjacently arranged gas diffusion layer 5. Furthermore, the connecting portions 12 have lateral surfaces 31 and the main ducts 11 have floor surfaces 33.

FIG. 2 shows a fuel cell setup comprising a plurality of distributor plates 7 and membrane electrode assemblies 4 having membranes 2. Oxygen 43, or air in which oxygen 43 is contained, and hydrogen 45 are conducted to the membrane-electrode assemblies 4 through the distributor plates 7. Water 51 is discharged in the main ducts 11 of the distributor plates 7 in which oxygen 43, or air in which oxygen 43 is contained, is supplied. In addition, the distributor plates 7 serve to guide a coolant 49.

FIG. 3 shows a contact region 47 between a gas diffusion layer 5 and a distributor plate 7. A connecting portion 12 of the distributor plate 7 is in contact with the gas diffusion layer 5 here. Furthermore, a coating 37 is arranged on the connecting portion 12 of the distributor plate 7. Hydrogen 45 passes from the main ducts 11 through the gas diffusion layer 5 to the electrode layer 3, which is arranged on the membrane 2.

FIG. 4 shows a top perspective view of a detail of a distributor plate 7 with secondary ducts 15 partially arranged within the distributor ducts 60. The distributor plate 7 alternately has main ducts 11 and connecting portions 12. A main current direction 53 is present along the main ducts 11. Relative to the orientation of the main ducts 11, an assembly angle 72 is designated. Furthermore, the main ducts 11 have a respective axis of symmetry 55.

The connecting portions 12 have a respective surface 13, of which the parts arranged at an angle to the floor surfaces 33 of the main ducts 11 are referred to as lateral surfaces 31. Distributor ducts 60 are arranged in the contact region 47 of the surface 13 of the connecting portions 12. The floor surfaces 33 of the main ducts 11 connect to the lateral surfaces 31 of the connecting portions 12.

Four distributor ducts 60 have a respective secondary duct 15, which guides water 51 to an adjacent main duct 11 or to an adjacent lateral surface 31, and thus connects the respective distributor duct 60 to the main duct 11 or to the lateral surface 31.

The auxiliary ducts 15 each run partially in the distributor ducts 60, the auxiliary ducts 15 being arranged in a floor 88 of the distributor ducts 60. Accordingly, the secondary ducts 15 are arranged in part in the contact region 47 to a gas diffusion layer 5.

A first part 17 of each secondary duct 15 is arranged at a first angle 19 to the adjacent main duct 11 and a second part 21 of each secondary duct 15 is arranged at a second angle 23 to the adjacent main duct 11. The secondary ducts 15 shown in this case have a curvilinear profile, so that their arrangement changes relative to the neighboring main duct 11 with the profile. The secondary ducts 15 are respectively arranged on the distributor ducts 60 substantially perpendicular to the main duct 11 and arranged in the main duct 11 or in the vicinity of the main duct 11 substantially parallel to the main duct 11.

A first secondary duct 82 terminates on a planar part 62 of the floor surface 33 of the adjacent main duct 11. A second secondary duct 84 terminates at an edge 59 between the floor surface 33 of the main duct 11 and the lateral surface 31 of the connecting portion 12. A third secondary duct 86 terminates on the lateral surface 31 of the connecting portion 12 so that water 51 can drain from the lateral surface 31 onto the floor surface 33 of the adjacent main duct 11. Furthermore, a first cutting plane 78 and a second cutting plane 80 are marked.

FIG. 5 shows a cross-sectional view along the first cross-sectional plane 78 shown in FIG. 4. Arranged in the surface 13 of the connecting portion 12 is the distributor duct 60 and arranged in the floor 88 of the distributor duct 60 is the secondary duct 15, which has a depth 27 and a width 29.

FIG. 6 shows a cross-sectional view along the second cross-sectional plane 80 shown in FIG. 4. The second secondary duct 84 is arranged at the edge 59 between the lateral surface 31 and the floor surface 33. The third secondary duct 86 is located in the lateral surface 31 of the connecting portion 12.

FIG. 7 shows a top perspective view of a detail of a distributor plate 7 having a distributor duct 60 that opens into an end structure 64 with more than two sub-ducts 66. A plurality of sub-ducts 66 are present, each having a same length 90 but being arranged offset from one another. The end structure 64 is arranged on the floor surface 33 of the main duct 11.

FIG. 8 shows a further embodiment of an end structure 64, with the sub-ducts 66 each having different lengths 90 and the length 90 within the end structure 64 decreasing from inward to outward.

FIG. 9 shows yet another embodiment of an end structure 64 with sub-ducts 66, the sub-ducts 66 being arranged in groups offset from one another.

FIG. 10 shows a top perspective view of a detail of a distributor plate 7 with distributor ducts 60, secondary ducts 15 and further secondary ducts 70. The secondary ducts 15 are partially arranged within the distributor ducts 60 and all open up into a further secondary duct 70, which is arranged along an axis of symmetry 55 of the main duct 11. The arrangement angle 72 of the further secondary ducts 70 is 0° in the illustrated embodiment, and correspondingly the further secondary ducts 70 run parallel to the main duct 11. Furthermore, the width 29 and depth 27 of the secondary ducts 15 in the distributor ducts 60 increase in the discharge direction.

FIG. 11 shows a top plan view of a detail of a distributor plate 7 with secondary ducts 15, which have a curved profile at the transition from a first part 17 to a second part 21 of the secondary ducts 15.

The first part 17 of the secondary ducts 15 is respectively arranged at a first angle 19 to the main ducts 11 having a main flow direction 53. The second part 21 of the secondary ducts 15 is respectively arranged at a second angle 23 to the main ducts 11 and the main flow direction 53.

Furthermore, the secondary ducts 15 have end regions 25 that open into the main ducts 11 so that droplets of water 51 from the secondary ducts 15 debond into the main ducts 11.

FIG. 12 shows an end region 25 of a secondary duct 15. In the illustrated embodiment, the secondary duct 15 has a V-shaped cross-sectional surface area 35. The secondary duct 15 has a depth 27 which decreases in the end region 25 and a width 29 which increases in the end region 25. Due to the altered geometry of the secondary duct 15 in the end region 25, water 51 logged in the secondary duct 15 in the form of droplets from the secondary duct 15 debonds and is carried along in the main flow direction 53 of the main duct 11. The end region 25 can have a coating 37.

FIG. 13 shows a plan view of a distributor plate 7 having three regions 94 in which a pattern 92 of the surfaces 13 of the connecting portions 12 each differs from one another.

The distributor plate 7 shown has an inlet region 96 with port structures 100, a first region 104, a second region 106, a third region 108, and an outlet region 98, also with port structures 100, in a main flow direction 53 of a mixture 42 one behind the other. Together, the three regions 94 represent an active surface 102 of the distributor plate 7. The patterns 92 in the regions 94 are respectively adjusted to the local reaction conditions, because a content of oxygen 43 in the mixture 42 decreases in the main flow direction 53 while a content of water 51 and thus a proportion of liquid in the mixture 42 increases.

FIG. 14 shows a detail of a second, i.e. center, region 124 of a distributor plate 7. The connecting portion 12 has a coating 37 in a contact region 47, in which case the coating 37 has hydrophobic surface properties 134. Conversely, a lateral surface 31 of the connecting portion 12 and a floor surface 33 of an adjacent main duct 11 have hydrophilic surface properties 136. A plurality of secondary ducts 15 are arranged in the contact region 47 of the connecting portion 12, secondary ducts 15 having a hydrophobic secondary duct surface 130 being arranged so as to alternate with secondary ducts 15 having a hydrophilic secondary duct surface 132. The secondary ducts 15 with the hydrophilic secondary duct surface 132 extend from the contact region 47 to the lateral surface 31.

The hydrophobic secondary duct surfaces 130 were created by applying a hydrophobic coating 37 to a hydrophilic base plate 8 and only partially removing the hydrophobic coating 37 again, thus forming the secondary duct 15. A thickness 138 of the hydrophobic coating 37 has been removed again.

The hydrophilic secondary duct surfaces 132 were formed by applying the hydrophobic coating 37 to the hydrophilic base plate 8 and then locally completely removing the hydrophobic coating 37 again, such that portions of the hydrophilic base plate 8 are exposed and form the hydrophilic secondary duct surface 132. To form the hydrophilic secondary duct surfaces 132, only the hydrophobic coating 37 can be removed again, or an embossing can also be continued into the hydrophilic base plate 8 in order to create a deeper secondary duct 15.

The invention is not limited to the exemplary embodiments described herein and the aspects emphasized thereby. Rather, a variety of modifications within the scope of activities of a skilled person is possible within the range specified by the claims.

1. A distributor plate (7) for an electrochemical cell (1), wherein the distributor plate (7) has a structure comprising connecting portions (12) with surfaces (13), and main ducts (11) having floor surfaces (33),
wherein the surfaces (13) are provided with a pattern (92), and
wherein the distributor plate (7) has at least two regions (94) in which the patterns (92) on the surfaces (13) differ from one another.

2. The distributor plate (7) according to claim 1, wherein the distributor plate (7) has an inlet region (96) and an outlet region (98), each with a port structure (100), and the at least two regions (94) are arranged one behind the other between the inlet region (96) and the outlet region (98).

3. The distributor plate (7) according to claim 2, wherein a number of secondary ducts (15) for each surface increases in a direction from the inlet region (96) to the outlet region (98).

4. The distributor plate (7) according to claim 23, wherein at least a first region (94, 122), a second region (94, 124), and a third region (94, 126) are arranged one behind the other in the direction from the inlet region (96) to the outlet region (98), wherein
in the first region (94, 122) at least one of the secondary ducts (15) opens into an end structure (64), wherein the at least one secondary duct (15) in the end structure (64) branches into at least two sub-ducts (66),
the pattern (92) in the second region (94, 124) additionally having distributor ducts (60), wherein the distributor ducts (60) have a respective larger diameter than the secondary ducts (15), and/or
in the third region (94, 126) at least one of the secondary ducts is arranged with a first part (17) at a first angle (19) in a range from 30° to 150° in relation to the main ducts (11) and arranged with a second part (21) at a second angle (23) in a range of less than 45° in relation to the main ducts (11), and/or
wherein at least one of the secondary ducts (15) has a respective end region (25) in which a depth (27) of the at least one secondary duct (15) decreases in the direction of a closest main duct (11), and/or a width (29) of the at least one secondary duct (15) increases in a direction of a closest main duct (11).

5. The distributor plate (7) according to claim 3, wherein at least the first region (94, 122), the second region (94, 124), and the third region (94, 126) are arranged one behind the other in the direction from the inlet region (96) to the outlet region (98),
wherein the surfaces (13) of the connecting portions (12) have contact regions (47) and lateral surfaces (31), and wherein
in the first region (94, 122) in the contact regions (47) the secondary ducts (15) have hydrophobic secondary duct surfaces (112, 130) and, on the lateral surfaces (31) and the floor surfaces (33), there are at least partially hydrophilic surface properties (136),
the secondary ducts (15) in the second region (94, 124) partially having a hydrophobic secondary duct surface (112, 130) and partially having a hydrophilic secondary duct surface (112, 132), and/or
in the third region (94, 126) there are more secondary ducts (15) with a hydrophilic secondary duct surface (112, 132) than secondary ducts (15) with a hydrophobic secondary duct surface (112, 130).

6. The distributor plate (7) according to claim 1, wherein the secondary ducts (15) have a respective width (29) and/or a depth (27) in a range from 1 μm to 150 μm.

7. A method for producing a distributor plate (7) according to claim 1, wherein a hydrophobic coating (37) is first applied to a hydrophilic base plate (8), and then a layer of the hydrophobic coating (37) is partially removed in different thicknesses (138) such that secondary ducts (15) are created and, depending on a thickness (138) of the removed layer, have a hydrophobic secondary duct surface (112, 130) or a hydrophilic secondary duct surface (112, 132).

8. An electrochemical cell (1) having a distributor plate (7) according claim 1, wherein the distributor plate (7) is arranged in a cathode space (39) of the electrochemical cell (1).

9. A method for operating an electrochemical cell (1), wherein a mixture (42) having a first composition is fed into a distributor plate (7) according to claim 1, said mixture (42) having a second composition and being discharged from the distributor plate (7), wherein the pattern (92) varies depending on a local composition of the mixture (42).

10. The method according to claim 9, wherein at least a first region (94, 122), a second region (94, 124), and a third region (94, 126) are arranged one behind the other in a direction from an inlet region (96) to an outlet region (98), wherein
in the first region (94, 122) the pattern (92) is designed in view of a distribution of the mixture (42) and optionally a vaporization of water (51),
the pattern (92) in the second region (94, 124) being designed in view of the vaporization of water (51) and optionally a discharge of liquid water (51), and/or
the pattern (92) in the third region (94, 126) being designed in view of the discharge of liquid water (51).

11. The distributor plate (7) according to claim 1, further comprising secondary ducts (15) having floor surfaces (33) also having the pattern (92).

12. The distributor plate (7) according to claim 4, wherein the at least two sub-ducts (66) have a respective smaller diameter than the at least one secondary duct (15).

13. The distributor plate (7) according to claim 4, wherein the pattern (92) additionally comprises the distributor ducts (60).

14. The distributor plate (7) according to claim 5, wherein, in the second region (94, 124), secondary ducts (15) having a hydrophobic secondary duct surface (112, 130) and secondary ducts (15) having a hydrophilic secondary duct surface (112, 132) are arranged in alternation.

15. The method according to claim 9, wherein the first composition comprises oxygen (43) and the second composition comprises water (51).
